(19) United States
(12) Patent Application Publication
(10) Pub. No.: US 2020/0063337 A1
(43) Pub. Date: Feb. 27, 2020

(54) SOFT ARTIFICIAL LEATHER FOR INTERIOR MATERIALS OF AUTOMOBILES AND METHOD FOR MANUFACTURING THE SAME

(71) Applicants: Hyundai Motor Company, Seoul (KR); KIA Motors Corporation, Seoul (KR); LG Hausys, Ltd., Seoul (KR)

(72) Inventors: Yong-Bae Jeong, Ulsan (KR); Chul-Hee Min, Ulsan (KR); In-Hyuk Lee, Ulsan (KR); Hyun-Dae Cho, Gyeonggi-do (KR); Hong-Mo Koo, Gyeonggi-do (KR); Hyung-Joon Youn, Gyeonggi-do (KR); Soon-Joon Jung, Gyeonggi-do (KR)

(73) Assignees: Hyundai Motor Company, Seoul (KR); KIA Motors Corporation, Seoul (KR); LG Hausys, Ltd., Seoul (KR)

(21) Appl. No.: 16/186,057

(22) Filed: Nov. 9, 2018

(30) Foreign Application Priority Data
Aug. 24, 2018 (KR) 10-2018-0099016

(51) Int. Cl. D06N 3/00; B32B 5/20; B32B 5/02; B32B 5/24; B32B 27/06; B32B 27/30; D06N 3/06; B32B 27/12; B32B 27/36

(52) U.S. Cl. CPC D06N 3/005; D06N 2211/26; B32B 5/024; B32B 5/245; B32B 27/065; B32B 27/304; D06N 3/0063; D06N 3/0077; D06N 3/0088; D06N 3/06; D06N 3/0006; B32B 27/12; B32B 27/36; B32B 2255/02; B32B 2255/26; B32B 2262/062; B32B 2262/0276; B32B 2266/0235; B32B 2605/003; D06N 2201/02; D06N 2201/042; D06N 2203/048; D06N 2205/04; D06N 2207/123; B32B 5/20

(57) ABSTRACT

Disclosed are an artificial leather used as an interior material for automobiles and a method for manufacturing the same, in one aspect a polymer plasticizer, a PVC resin and a foaming agent. The soft artificial leather for interior materials of automobiles includes a skin layer including a PVC resin and a primary plasticizer, wherein the skin layer further includes higher than 0 and not higher than 15 phr of a polymer plasticizer. As a result, there are effects of reducing heating loss and suppressing migration of the plasticizer.

### CROSS-REFERENCE TO RELATED APPLICATION

This application claims priority to and the benefit of Korean Patent Application No. 10-2018-0099016, filed on Aug. 24, 2018, the entire contents of which is incorporated herein by reference.

### FIELD

The present disclosure relates toan artificial leather, such as may be used as an interior material for automobiles, and a method for manufacturing the same.

### BACKGROUND

The statements in this section merely provide background information related to the present disclosure and may not constitute prior art.

Artificial leather for interior materials of automobiles is a material that a consumer directly contacts and touches while driving, which can be formed by sequentially laminating a foaming layer, a skin layer, and a surface coating layer on a woven fabric layer in order to impart ornamental functions in automobiles and durability upon use as well as flexibility to the artificial leather.

Artificial leather may have difficulty exhibiting texture comparable to natural leather due to lack of flexibility and cushioning. In some instances, increasing the amount of a softening additive, for example, a plasticizer, contained in the skin layer has been attempted, or further forming foamed cells in the foaming layer or the like has been tried.

However, we have discovered that when the amount of plasticizeris increased, the increased plasticizer content results in an increase in heating loss, and the plasticizer migrates to the surface of artificial leather when continuously heated due to low molar weigh thereof, which may cause damage to the appearance of artificial leather. In addition, we have found there is a limitation on decreasing surface hardness and increasing softness.

### SUMMARY

Disclosed herein is a method to reduce heating loss and suppress migration in spite of increased plasticizer content, and a composition made by said method.

In addition, the present disclosure provide an artifical leather having softness and surface hardness comparable to natural leather.

In addition, the present disclosure describes a method to reduce burst of foamed cells and depression of foamed cells and to substantially uniformly form foamed cells in spite of increased foaming agent content and infrared heating.

In one aspect, a soft artificial leather for interior materials of automobiles including a skin layer including a PVC resin and a primary plasticizer is described, wherein the skin layer further includes higher than 0 and not higher than 15 parts per hundred rubber (phr) of a polymer plasticizer.

In one aspect, the molar weight of the polymer plasticizer may be higher than 2,000 g/mol and lower than 3,000 g/mol.

In one aspect, the polymer plasticizer may include, as a repeat unit, at least one selected from the group consisting of dioctyladipate, acrylonitrile, methyl methacrylate, butyl acetate and dioctyl-terephthalate.

In one aspect, the primary plasticizer may have a content of 80 phr or less.

In one form, the primary plasticizer may include at least one selected from the group consisting of tri-ethylhexyl trimellitate, diisodecyl phthalate, diisononyl phthalate, dipropylheptyl phthalate and dipentyl phthalate.

In one aspect, the PVC resin may be a straight resin having a polymerization degree of 1,300 or more.

In one form, the soft artificial leather may further include a foaming layer, wherein the foaming layer is formed using a composition for forming the foaming layer including 6 phr or more of a foaming agent.

In one aspect, the composition for forming the foaming layer may include higher than 0 and not higher than 1 phr of a ZnO-based inorganic surfactant.

In one form, the soft artificial leather may further include a surface coating layer, wherein the surface coating layer is subjected to vacuum embossing.

In another aspect, provided is a method for manufacturing a soft artificial leather for interior materials of automobiles including producing a laminate including adding a foaming agent to a PVC resin having a first polymerization degree to form a preliminary foaming layer, and laminating a skin layer including a mixture of a PVC resin having a second polymerization degree and being plasticized by a primary plasticizer and a polymer plasticizer on the preliminary foaming layer, foaming the preliminary foaming layer, forming a surface coating layer on a surface of the foamed laminate, and heating the foamed laminate using an infrared heater.

The PVC resin may have a second polymerization degree may have a polymerization degree of 1,300 or more.

A heating temperature of the infrared heater may be 500° C. or higher.

In the step of forming the preliminary foaming layer, 1 phr or less of a ZnO-based inorganic surfactant may be added.

The method may further include subjecting a surface of the heated laminate to vacuum embossing to transfer an embossed pattern to the surface of the laminate.

The polymer plasticizer may have a content of 15 phr or less.

The polymer plasticizer has a molar weight of less than 3,000 g/mol.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an image showing migration of a plasticizer in a Comparative Example;

FIG. 2 is an image showing non-uniform formation of foamed cells in a Comparative Example;

FIG. 3 is an image showing non-uniform formation of foamed cells in a Comparative Example;

FIG. 4 is an image showing depressed foamed cells in a Comparative Example;

FIG. 5 is an image showing reduction in migration of plasticizer;

FIG. 6 is an image showing stable formation of foamed cells with a substantially uniform size and uniform foaming;

FIG. 7 is an image showing substantially uniform formation of foamed cells; and

FIG. 8 is an image showing reduction in depression of foamed cells.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The description herein is made in detail with reference to the annexed drawings, but is not limited or specified to the examples, and effects will be naturally or more clearly understood from the following description and are not limited by the description. In addition, the detailed description of the prior art will be omitted when it could obscure relevant subject matter.

The soft artificial leather mentioned in the present specification means an artificial leather having a softness of 3.5 mm or more, wherein the softness is measured, based on MS 300-31 (Sec. 4.32). The present disclosure relates to an artificial leather characterized in that it includes a skin layer including a PVC resin and a primary plasticizer, and the skin layer further includes higher than 0 phr and not higher than 15 phr of a polymer plasticizer.

When 90 phr or more of a plasticizer is added to produce artificial leather, heating loss is increased and the plasticizer with a low molar weight migrates to the surface of artificial leather, upon continuous exposure to heat. The present disclosure describes that PVC resin be plasticized into a long chain structure using the primary plasticizer and is then mixed with the polymer plasticizer with low heating loss and migration.

The content of the polymer plasticizer is set to at most 15 phr because, when the content is higher than 15 phr, plasticization of the PVC resin may not proceed sufficiently during mixing.

The molar weight of the polymer plasticizer may be higher than 2,000 g/mol and lower than 3,000 g/mol. When the molar weight is 2,000 g/mol or less, the polymer plasticizer may migrate to the surface of the artificial leather due to low molar weight, and when the molar weight is 3,000 g/mol or more, process ability may be deteriorated due to increased viscosity.

The polymer plasticizer may be a polymer which includes, as a repeated unit, at least one selected from the group consisting of dioctyl adipate, acrylonitrile, methyl methacrylate, butyl acetateanddioctyl-terephthalate, but is not limited thereto. The polymer plasticizer disclosed herein may be a polymer of any plasticizer that has a similar structure thereto.

The content of the primary plasticizer included in the skin layer may be 80 phr or less, and the primary plasticizer may include at least one selected from the group consisting of tri-ethylhexyl trimellitate, diisodecyl phthalate, diisononyl phthalate, dipropylheptyl phthalateanddipentyl phthalate, but is not limited thereto. The primary plasticizer disclosed herein may be a polymer of any plasticizer that has a similar structure thereto.

Meanwhile, in addition to the polyvinyl chloride (PVC) resin included, a polyvinylidene chloride (PVDC) resin, a polyvinylidene fluoride (PVF) resin, a chlorinated polyvinyl chloride (CPVC) resin, a polyvinylalcohol (PVA) resin, a polyvinylacetate (PVAc) resin, a polyvinylbutyrate (PVB) resin, a polyethylene (PE) resin or a polypropylene (PP) resin may be used.

The PVC resin included in the skin layer may have a polymerization degree of 1,300 or more. The polymerization degree of the PVC resin is set to 1,300 or more because, when heating with an infrared heater in order to further form foamed cells, a PVC resin having a polymerization degree of less than 1,300 may cause burst of foamed cells and depression of foamed cells constituting a foaming layer due to insufficient physical properties, that is, insufficient durability at a heating temperature of 500° C. or higher. The heating means is not limited to an infrared heater and may include Raymax®, quartz and other infrared equipment.

A surface coating layer may be formed on the skin layer and an embossed pattern may be transferred to the surface of the surface coating layer. The embossed pattern functions to impart excellent surface texture to the artificial leather and improve surface durability.

A method for forming the embossed pattern includes a roll (press) embossing means, a vacuum embossing means (hereinafter referred to as “vacuum embossing”) and the like. Since roll embossing is conducted at high pressure, it causes damage to the structure of foamed cells and thus has a difficulty of providing a predetermined level of cushioning. On the other hand, vacuum embossing can maintain characteristics of foamed cells, because the embossed pattern can be transferred by adsorbing a sheet under vacuum without applying heat and pressure. The embossed pattern may, in one aspect, be transferred by vacuum embossing.

In one aspect, the foaming layer disposed under the skin layer is formed using a composition for forming a foaming layer including higher than 0 and not higher than 1 phr of a ZnO-based inorganic surfactant and 6 phr or more of a foaming agent.

When the foaming agent is added in an amount of 6 phr or more, foamed may cells burst, and foamed cells may be non-uniformly formed. We have discovered that addition of a ZnO-based inorganic surfactant can reduce this phenomenon. The ZnO-based inorganic surfactant facilitates foaming of the foaming agent and acts synergistically with a heat stabilizer which is used in combination with the ZnO-based inorganic surfactant to uniformly form foamed cells and thereby impart stable cushioning to the artificial leather.

The content of the ZnO-based inorganic surfactant may be higher than 0 and not higher than 1 phr. The content of the inorganic surfactant is set at most to 1 phr because, when the ZnO-based inorganic surfactant is used in an amount higher than 1 phr, early foaming can occur during calender finishing. By adding the inorganic surfactant, although the foaming agent is present in an amount of 6 phr or more in the production of artificial leather, burst of foamed cells can be reduced, and foamed cells can be uniformly or substantially uniformly formed.

Hereinafter, specific examples will be described in more detail. These examples are provided only for illustration, and the scope of the present disclosure is not limited thereto.

### Example 1

A fabric layer was formed to a thickness of 0.6 mmT using a fabric including cotton and polyester in a ratio of 35:65. Alternatively, a fabric containing 100% cotton or 100% polyester may also be used.

80 phr of a primary plasticizer having a molar weight of about 450 g/mol, 15 phr of a polymer plasticizer having a molar weight of about 2,500 g/mol, 6 phr of a foaming agent and 1 phr of a ZnO inorganic surfactant were added to 100 parts by weight of a PVC straight vinyl chloride homopolymer having a polymerization degree of 1,000, to prepare a foaming layer composition, and a fabric layer was coated with the foaming layer composition, followed by drying, to form a preliminary foaming layer having a thickness of 0.1 mmT to 0.3 mmT.

80 phr of a primary plasticizer having a molar weight of about 450 g/mol, and 15 phr of a polymer plasticizer having a molar weight of about 2,500 g/mol were added to 100 parts by weight of a straight vinylchloride homopolymer having a polymerization degree of 1,300, to form a skin layer with a thickness of 0.1 mmT to 0.3 mmT.

Sequentially, a laminate including the preliminary foaming layer and the skin layer sequentially laminated on the fabric layer was produced through a calender process and the preliminary foaming layer was foamed in an about 230° C. oven.

Then, the skin layer was Gravure-coated with a polycarbonate-based polyurethane aqueous surface treatment agent and the aqueous solvent was evaporated at 140° C., to form a surface treatment layer with a thickness of 5 μm to 20 μm, or 8 to 12 μm (Gravure printing roll surface treatment process).

The laminate was heated to about 500° C. with an infrared heater and then the surface of the vacuum surface treatment layer was subjected to vacuum embossing at a vacuum-level pressure of 0.06 Mpa to produce an artificial leather.

### Example 2

An artificial leather was produced in the same manner as in Example 1, except that the primary plasticizer was included in an amount of 70 phr and the polymer plasticizer was included in an amount of 10 phr.

### Comparative Example 1

An artificial leather was produced in the same manner as in Example 1, except that a straight vinylchloride homopolymer having a polymerization degree of 1,000 was used for the skin layer, the primary plasticizer was included in an amount of 70 phr, the polymer plasticizer was not included, the ZnO inorganic surfactant was not included, the foaming agent was included in an amount of 5 phr, press embossing was conducted and a hot oven was used as a heating means.

### Comparative Example 2

An artificial leather was produced in the same manner as in Example 1, except that a straight vinyl chloride homopolymer having a polymerization degree of 1,000 was used for the skin layer, the polymer plasticizer was not included, the ZnO inorganic surfactant was not included, the foaming agent was included in an amount of 5 phr, press embossing was conducted, and a hot oven was used as a heating means.

### Comparative Example 3

An artificial leather was produced in the same manner as in Example 1, except that a straight vinyl chloride homopolymer having a polymerization degree of 1,000 was used for the skin layer, the primary plasticizer was included in an amount of 95 phr, the polymer plasticizer was not included, the ZnO inorganic surfactant was not included, the foaming agent was included in an amount of 5 phr, press embossing was conducted, and a hot oven was used as a heating means.

### Comparative Example 4

An artificial leather was produced in the same manner as in Example 1, except that a straight vinyl chloride homopolymer having a polymerization degree of 1,000 was used for the skin layer, the ZnO inorganic surfactant was not included, the foaming agent was included in an amount of 5 phr, press embossing was conducted, and a hot oven was used as a heating means.

### Comparative Example 5

An artificial leather was produced in the same manner as in Example 1, except that a straight vinyl chloride homopolymer having a polymerization degree of 1,000 was used for the skin layer, and the ZnO inorganic surfactant was not included.

### Comparative Example 6

An artificial leather was produced in the same manner as in Example 1, except that a straight vinyl chloride homopolymer having a polymerization degree of 1,000 was used for the skin layer.

### Comparative Example 7

An artificial leather was produced in the same manner as in Example 1, except that the primary plasticizer was included in an amount of 70 phr, the polymer plasticizer was not included, the ZnO inorganic surfactant was not included, the foaming agent was included in an amount of 5 phr, press embossing was conducted, and a hot oven was used as a heating means.

The following table shows specific compositions of Examples and Comparative Examples in brief.

TABLE 1

| | | | Comparative | Comparative | Comparative |
|---|---|---|---|---|---|
| Items | Example1 | Example2 | Example 1 | Example 2 | Example 3 |
| PVC polymerization degree (skin layer) | 1,300 | 1,300 | 1,000 | 1,000 | 1,000 |
| PVC polymerization degree(foaming layer) | 1,000 | 1,000 | 1,000 | 1,000 | 1,000 |
| Primary plasticizer (phr) | 80 | 70 | 70 | 80 | 95 |
| Polymer plasticizer (phr) | 15 | 10 | 0 | 0 | 0 |
| Total plasticizer content (phr) | 95 | 80 | 70 | 80 | 95 |
| ZnO inorganic surfactant (phr) | 1 | 1 | 0 | 0 | 0 |
| Foaming agent (phr) | 6 | 6 | 5 | 5 | 5 |
| Embossing means | Vacuum | Vacuum | Press | Press | Press |
| Heating means | Infrared | Infrared | Hot oven | Hot oven | Hot oven |
| | heater | heater | | | |

TABLE 2

| | Comparative | Comparative | Comparative | Comparative |
|---|---|---|---|---|
| Item | Example 4 | Example 5 | Example 6 | Example 7 |
| PVC polymerization degree (skin layer) | 1,000 | 1,000 | 1,000 | 1,300 |
| PVC polymerization degree (foaming layer) | 1,000 | 1,000 | 1,000 | 1,000 |
| Primary plasticizer (phr) | 80 | 80 | 80 | 70 |
| Polymer plasticizer (phr) | 15 | 15 | 15 | 0 |
| Total plasticizer content (phr) | 95 | 95 | 95 | 70 |
| ZnO inorganic surfactant (phr) | 0 | 0 | 1 | 0 |
| Foaming agent (phr) | 5 | 6 | 6 | 5 |
| Embossing means | Press | Vacuum | Vacuum | Press |
| Heating means | Hot oven | Infrared | Infrared | Hot oven |
| | | heater | heater | |

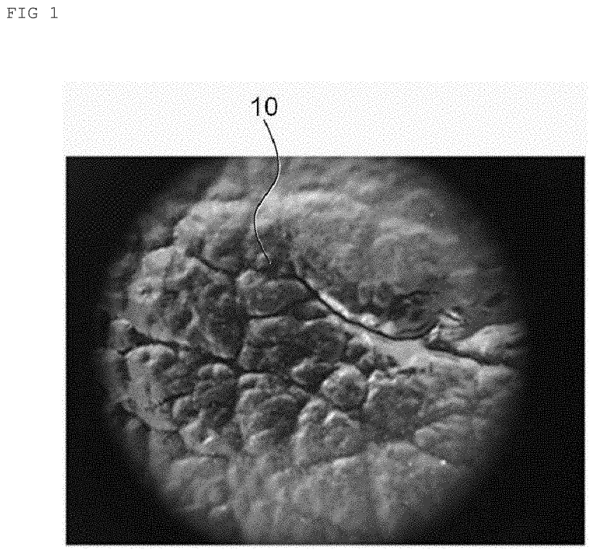

Surface hardness, softness, foamed cell uniformity, heating loss, appearance and the like were measured regarding respective artificial leathers of Examples and Comparative Examples and results are shown in the following tables. The measurement of softness was carried out using anST300D manufactured by BLC, in accordance with MS 300-31 (Sec. 4.32) and the surface hardness measurement device herein used was an MD-1, Shore Type A (indentor specifications: 0.50H ϕ 0.16 cylinder) manufactured by Asker Limited. FIGS. 1 to 8 are optical microscopic images regarding Comparative Examples and Examples, and the images were obtained using a HI-SCOPE KH-2200 manufactured by HIROX Co., Ltd.

TABLE 3

| | | | Comparative | Comparative | Comparative |
|---|---|---|---|---|---|
| Item | Example 1 | Example 2 | Example 1 | Example 2 | Example 3 |
| Surface hardness(Hk) | 45 | 50 | 65 | 62 | 55 |
| Softness(mm) | 4.1 | 3.8 | 3.5 | 3.6 | 3.8 |
| Embossing | ∘ | ∘ | ∘ | ∘ | ∘ |
| Foamed celluniformity | ∘ | ∘ | x | x | x |
| Heating loss(%) | 1 or less | 1 or less | 1 or less | 1.5 | 3.5 |
| Appearance | ∘ | ∘ | ∘ | ∘ | Δ |
| | | | | | (plasticizer |
| | | | | | migration) |
| Feel | ∘ | ∘ | Δ | Δ | Δ |

TABLE 4

| | Comparative | Comparative | Comparative | Comparative |
|---|---|---|---|---|
| item | Example 4 | Example 5 | Example 6 | Example 7 |
| surface hardness(Hk) | 55 | 45 | 45 | 65 |
| Softness(mm) | 3.8 | 4.1 | 4.1 | 3.5 |
| Embossing | ∘ | ∘ | ∘ | ∘ |
| Foamed cellsuniformity | x | Δ | ∘ | x |
| Heating loss(%) | 1 or less | 1 or less | 1 or less | 1 or less |
| Appearance | ∘ | Δ | Δ | ∘ |
| | | (foam burst) | (foam burst) | |
| | | (depression) | (depression) | |
| Feel | Δ | ∘ | ∘ | Δ |

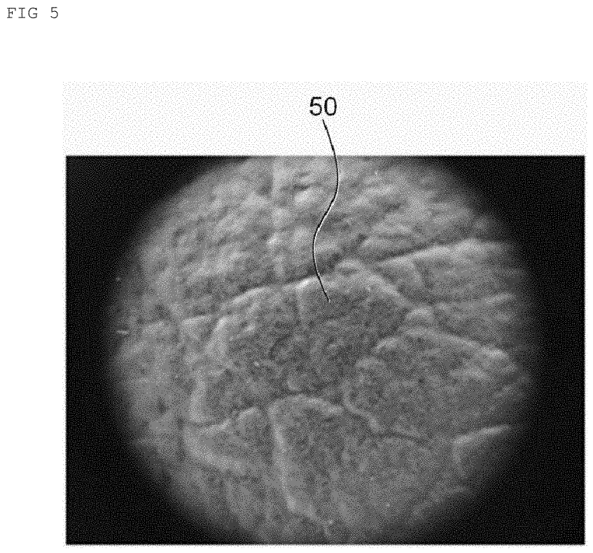

Hereinafter, test results shown in Tables 3 and 4 will be described in detail. First, results of Comparative Examples will be described with reference to FIGS. 1 to 4 and then results of Examples will be described with reference to FIGS. 5 to 8.

When it comes to heating loss and migration of the plasticizer, Comparative Examples 1 to 3 exhibited an increase in heating loss, as the content of primary plasticizer increased, and Comparative Example 3 including 95 phr of a primary plasticizer showed migration 10 of the plasticizer, as shown in FIG. 1.

Comparing Comparative Example 3 with Comparative Example 4, although the total content of the plasticizer is identical at 95 phr, Comparative Example 4 including 15 phr of the polymer plasticizer had heating loss of 1% or less and had no migration of plasticizer. This means that 15 phr or less of the polymer plasticizer is effective in reducing heating loss and suppressing migration of the plasticizer.

Considering a decrease in surface hardness and an increase in softness, Comparative Examples 1 to 3 exhibited decreased surface hardness, but increased softness, as the content of the primary plasticizer increased.

Comparing Comparative Example 4 with Comparative Example 5, unlike Comparative Example 4 wherein a laminate including the foaming layer containing 5 phr of the foaming agent was heated in a hot oven, Comparative Example 5 wherein a laminate including the foaming layer containing 6 phr of the foaming agent was heated by an infrared means exhibited lower surface hardness and higher softness. This means that 6 phr of the foaming agent and infrared heating is effective in reducing surface hardness and improving softness.

Before reviewing the uniformity of foamed cells, meanings of symbols, ∘, Δ and x, shown in Tables 3 and 4, will be described. The symbol “∘” means that uniform foamed cells are obtained, the symbol“Δ” means that uniformity of foamed cells is slightly improved, and the symbol “x” means that foamed cells are not formed uniformly, as the embossed pattern is transferred by press embossing.

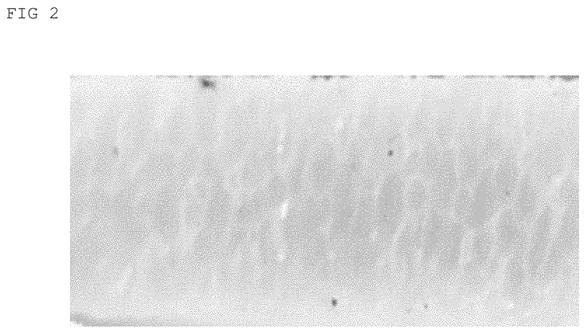

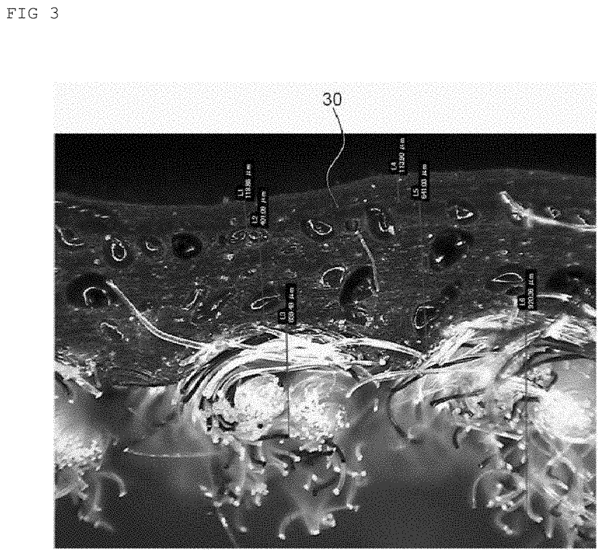

Comparing Comparative Example 4 with Comparative Example 5, Comparative Example 5 showed burst of foamed cells and non-uniform formation of foamed cells, as shown in FIGS. 2 and 3, because the inorganic surfactant was not added, although 6 phr of the foaming agent was added.

Comparing Comparative Example 5 with Comparative Example 6, although the content of the foaming agent was equivalent, Comparative Example 6 exhibited improved uniformity of foamed cells, because 1 phr of the inorganic surfactant was included therein. This means that addition of the inorganic surfactant is effective in improving uniformity of foamed cells.

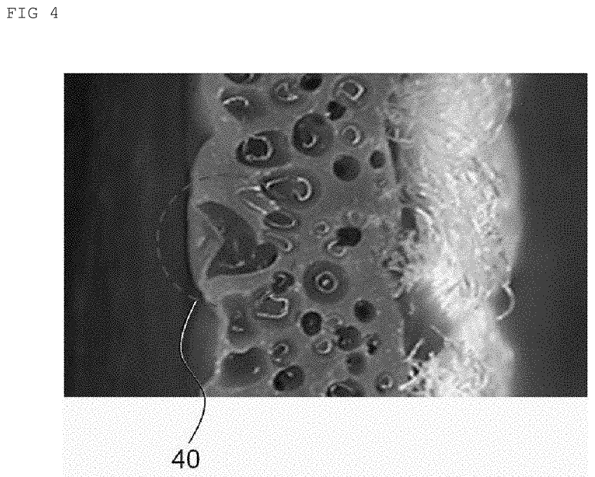

Since Comparative Example 6 contains an inorganic surfactant, burst of foamed cells and depression of foamed cells 40 of Comparative Example 6, as shown in FIG. 4, are caused by the fact that the polymerization degree of the PVC resin included in the skin layer is 1,000.

This means that the addition of the ZnO-based inorganic surfactant and the PVC resin having a polymerization degree of 1,300 or more are effective in reducing burst of foamed cells and depression of foamed cells, which are caused by addition of 6 phr or more of a foaming agent and infrared heating at 500° C. or higher.

Example 1 included a skin layer containing 15 phr of a polymer plasticizer and thus exhibited a heating loss of 1% or less. As can be seen from FIG. 5, migration 50 of the plasticizer was observed, but was reduced, as compared to Comparative Example 3. As the skin layer contained the PVC straight resin with a polymerization degree of 1,300 and the foaming layer contained 6 phr of the foaming agent, softness of 4.1 mm and surface hardness of 45 Hk could be obtained.

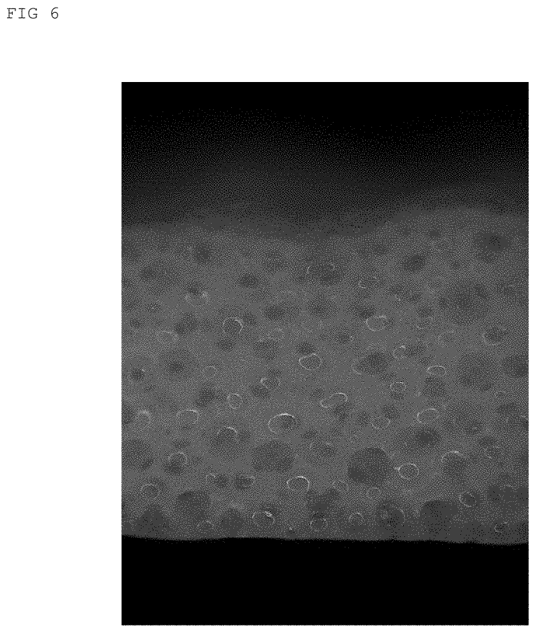

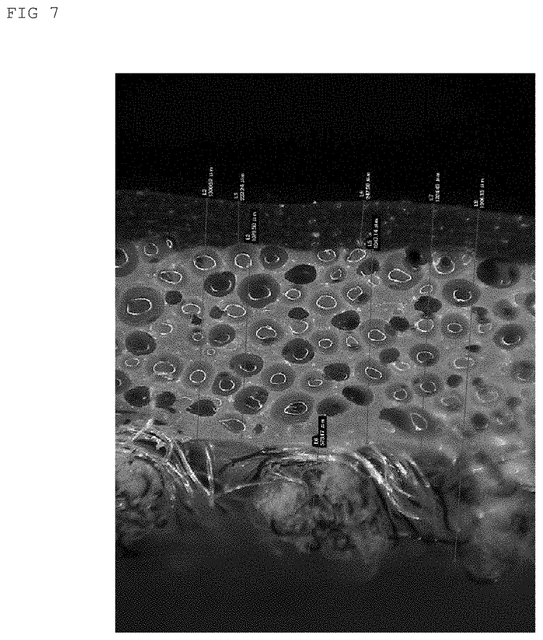

As can be seen from FIGS. 6 and 7 showing the foaming layer of Example 1, foamed cells were uniformly formed and there was no burst of foamed cells, since the foaming layer contained 1 phr of an inorganic surfactant and vacuum embossing was applied to the laminate, although the foaming layer contained 6 phr of a foaming agent.

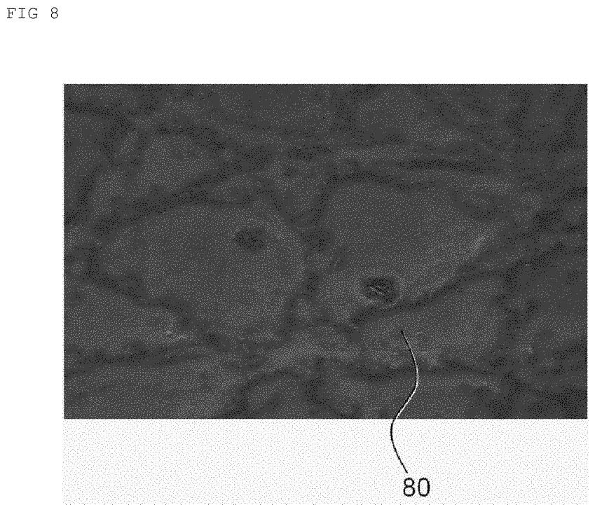

Although infrared heating was conducted at 500° C. in the manufacturing process, the polymerization degree of the PVC resin included in the skin layer was 1,300, which means that depression 80 of foamed cells was reduced, as shown in FIG. 8.

Comparing Examples 1 and 2, Example 2 exhibited softness, as an artificial leather for interior materials of automobiles, comparable to natural leather (3.2 mm), although the content of the primary plasticizer and the content of the polymer plasticizer were decreased. Meanwhile, artificial leather having a softness of 3.5 mm or more was considered to have a hardness of 50 Hk or less.

Those skilled in the art will appreciate that various modifications, additions and substitutions are possible, without departing from the scope and spirit of the present disclosure in the accompanying claims. Therefore, the scope should not be limited to the aforementioned examples.

As described herein, the present method and composition can reduce heating loss and suppress migration in spite of increased plasticizer content.

Also, the present artificial leather can provide softness and surface hardness, comparable to natural leather.

Also, the present method can reduce burst of foamed cells and depression of foamed cells and, at the same time, uniformly form foamed cells in spite of increased foaming agent content and infrared heating.

What is claimed is:

1. A soft artificial leather for interior materials of automobiles comprising a skin layer including a PVC resin and a primary plasticizer,
wherein the skin layer comprises higher than 0 and not higher than 15 phr of a polymer plasticizer.

2. The soft artificial leather according to claim 1, wherein a molar weight of the polymer plasticizer is higher than 2,000 g/mol and lower than 3,000 g/mol.

3. The soft artificial leather according to claim 2, wherein the polymer plasticizer comprises, as a repeat unit, at least one selected from the group consisting of dioctyl adipate, acrylonitrile, methyl methacrylate, butyl acetateanddioctyl-terephthalate.

4. The soft artificial leather according to claim 1, wherein the primary plasticizer has a content of 80 phr or less.

5. The soft artificial leather according to claim 4, wherein the primary plasticizer comprises at least one selected from the group consisting of tri-ethylhexyl trimellitate, diisodecyl phthalate, diisononyl phthalate, dipropylheptyl phthalate and dipentyl phthalate.

6. The soft artificial leather according to claim 1, wherein the PVC resin is a straight resin having a polymerization degree of 1,300 or more.

7. The soft artificial leather according to claim 6, further comprising a foaming layer,
wherein the foaming layer is formed using a composition for forming the foaming layer comprising 6 phr or more of a foaming agent.

8. The soft artificial leather according to claim 7, wherein the composition for forming the foaming layer comprises higher than 0 and not higher than 1 phr of a ZnO-based inorganic surfactant.

9. The soft artificial leather according to any one of claims 1 to 8, further comprising a surface coating layer,
wherein the surface coating layer is subjected to vacuum embossing.

10. A method for manufacturing a soft artificial leather for interior materials of automobiles comprising:
producing a laminate comprising: adding a foaming agent to a PVC resin having a first polymerization degree to form a preliminary foaming layer; and laminating a skin layer including a mixture of a PVC resin having a second polymerization degree and being plasticized by a primary plasticizer and a polymer plasticizer on the preliminary foaming layer;
foaming the preliminary foaming layer;
forming a surface coating layer on a surface of the foamed laminate; and
heating the foamed laminate using an infrared heater.

11. The method according to claim 10, wherein the PVC resin having a second polymerization degree has a polymerization degree of 1,300 or more.

12. The method according to claim 11, wherein a heating temperature of the infrared heater is 500° C. or higher.

13. The method according to claim 10, wherein, in the step of forming the preliminary foaming layer, 1 phr or less of a ZnO-based inorganic surfactant is added.

14. The method according to claim 13, further comprising:
subjecting a surface of the heated laminate to vacuum embossing to transfer an embossed pattern to the surface of the laminate.

15. The method according to claim 11, wherein the polymer plasticizer has a content of 15 phr or less.

16. The method according to claim 15, wherein the polymer plasticizer has a molar weight of less than 3,000 g/mol.
